(19) United States
(12) Patent Application Publication
(10) Pub. No.: US 2009/0075050 A1
(43) Pub. Date: Mar. 19, 2009

(54) Addition of continuous elements to non-woven mat

(76) Inventors: Leonard J. Adzima, Pickerington, OH (US); Annabeth Law, Columbus, OH (US); Scott Schweiger, Newark, OH (US)

Correspondence Address: OWENS CORNING, 2790 COLUMBUS ROAD, GRANVILLE, OH, 43023, US

(21) Appl. No.: 11/901,410

(22) Filed: Sep. 17, 2007

(51) Int. Cl. B32B 21/02; D04H 3/08

(52) U.S. Cl. 428/292.1; 156/181

(57) ABSTRACT

A reinforced chopped strand mat formed of a plurality of chopped reinforcement fibers and at least one continuous element positioned in a substantially parallel orientation in the machine direction is provided. In the reinforced chopped strand mat, the fibers are dispersed in a randomly oriented configuration at least partially surrounding the continuous elements. In preferred embodiments, the continuous element is either a wet continuous glass strand or a dry continuous yarn. The continuous elements are positioned within the chopped strand mat in a parallel or substantially parallel orientation and may be substantially equidistant from each other or irregularly spaced. Desirably, the continuous elements are equidistantly spaced about 0.25 inches to about 3 inches apart. The continuous elements simultaneously improve tensile strength and tear strength of the reinforced chopped strand mat. Methods of forming the reinforced chopped strand mat are also provided.

### TECHNICAL FIELD AND INDUSTRIAL APPLICABILITY OF THE INVENTION

The present invention relates generally to non-woven fibrous mats, and more particularly, to the addition of parallel or substantially parallel continuous elements to a non-woven fibrous mat in the machine direction. Methods of forming such a reinforced non-woven mat are also provided.

### BACKGROUND OF THE INVENTION

Typically, glass fibers are formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the wet fibers may be gathered into one or more strands, chopped, and collected. The chopped strands may contain hundreds or thousands of individual glass fibers. The collected chopped glass strands may then be packaged in their wet condition as wet chopped fiber strands (WUCS) or dried to form dry chopped fiber strands (DUCS).

Wet chopped fibers are conventionally used in wet-laid processes in which the wet chopped fibers are dispersed in a water slurry that contains surfactants, viscosity modifiers, defoaming agents, and/or other chemical agents. The slurry containing the chopped fibers is then agitated so that the fibers become dispersed throughout the slurry. The slurry containing the fibers is deposited onto a moving screen where a substantial portion of the water is removed to form a web. A binder is then applied, and the resulting mat is dried to remove any remaining water and cure the binder. The formed non-woven mat is an assembly of dispersed, individual glass filaments.

Dried chopped strands are commonly used in dry-laid processes in which the dried strands are air blown onto a conveyor or screen and consolidated to form a mat. For example, dry chopped strands are suspended in air, collected as a loose web on a screen or perforated conveyor, and then consolidated to form a mat of randomly oriented bundles.

Fibrous mats formed by both wet-laid and dry-laid processes are extremely suitable as reinforcements for many types of applications. For example, wet-laid mats may be used in roofing applications, non-woven veil applications, or to form composite laminates or ceiling tiles. In order for the final product incorporating the mat to possess acceptable mechanical properties, such as adequate tear and tensile strength, it must include a sufficient amount by weight of both glass reinforcements and binder. Although the bundles of fibers present in the dry-laid mats can provide sufficient glass content, manufacturing dry chopped strands is expensive because such strands are dried and packaged in separate steps before being chopped. Because the fibers are not dried prior to use, wet-laid mats provide a lower cost alternative to the dry-laid mats. Besides their economic advantage, wet-laid mats have quick air releasing capacity and superior surface characteristics.

Attempts have been made to improve conventional chopped strand mats. Examples of such attempts are set forth below.

U.S. Pat. No. 3,044,146 to Thomas, et al. disclose methods which utilize limited quantities of continuous glass strand or yarn to maintain components of bonded fibrous glass materials in an evenly distributed and integrated form. In one embodiment, helical strands of continuous fibers are placed between two webs formed of cut glass strands bonded with a binder. The layers are then stitched together. In a second embodiment, continuous fibrous glass strands are laid upon a web of a bonded mat. A second bonded mat is placed on the continuous glass strands and the layers are stitched together. In a third embodiment, chopped glass fibers are sandwiched between two bonded mats and stitched to form a laminate structure. In a final embodiment, three webs of bonded chopped strands are stitched together.

U.S. Pat. No. 3,614,936 to Philipps teaches a non-woven structure that includes an accumulation of chopped glass strands held together by threads spaced sufficiently close so that the thread knits the discontinuous glass strands together into a coherent body. In another embodiment, continuous glass strands are positioned adjacent to each other in a parallel relationship lengthwise on major surfaces of a non-woven structure. The continuous glass strands are held onto the non-woven mat by threads. Because the stitching must unite the layer of discontinuous (e.g., cut) glass strands and the continuous glass strands, the stitches are spaced apart in nonlinear rows, such as in a zig-zag formation.

U.S. Pat. Nos. 5,129,131 and 5,540,986 to Kimura, et al. teach a stampable sheet of thermoplastic resin reinforced with a glass fiber mat that is formed of a layer of non-oriented continuous glass fibers and a layer of continuous unidirectional fibers. The two layers are needled to intertwine the two separate layers.

U.S. Pat. Nos. 6,268,047 and 6,680,115 to Mulder, et al. disclose a dual-layer mat formed of a first layer formed of generally parallel, essentially continuous glass fiber strands and a second layer positioned adjacent to the first layer and formed of randomly oriented chopped glass fibers strands. The two layers are entangled by a needling apparatus.

Although conventional wet-laid mats are continually being improved, historically, attempts to improve the tear strength have decreased the tensile strength. Thus, there remains a need in the art for a cost-effective and efficient process to improve both the tensile strength and tear strength of wet-laid mats and a chopped strand mat that exhibits such improved strengths.

### SUMMARY OF THE INVENTION

It is an object of the present invention to provide a reinforced chopped strand mat that includes (1) a plurality of randomly dispersed chopped reinforcement fibers bound together by a binder and (2) at least one continuous element positioned in a substantially parallel orientation in the machine direction. The continuous elements may be positioned such that the continuous elements are buried within the chopped glass fibers in the chopped strand mat. Alternatively, the continuous elements may be positioned near a surface of the chopped strand mat where the continuous elements are at least partially surrounded by the chopped glass fibers. The continuous element may be formed of any continuous fiber strand, thread, roving, or yarn that possesses reinforcing qualities, but is preferably formed of wet continuous glass strands. It is desirable that the continuous element has a bundle tex from about 50 to about 4800 tex. In addition, the fibers forming the continuous element preferably have diameters from about 7.5 to about 23 microns. The continuous elements may be substantially evenly spaced within the chopped strand mat (e.g., a distance from about ¼ of an inch to about 3 inches apart). Alternatively, some of the continuous elements in the chopped strand mat may be spaced closer to each other in one portion of the reinforced chopped strand mat and farther apart from each other in another portion of the reinforced mat, depending on the desired application.

It is also an object of the present invention to provide a method of forming a reinforced chopped strand mat that includes (1) depositing one or more continuous elements and chopped reinforcement fibers onto a foraminous conveying apparatus to form a non-woven web, (2) applying at least one binder to the non-woven web, and (3) drying the non-woven web to cure the binder and form a reinforced chopped strand mat. The continuous elements are positioned in a substantially parallel orientation in the machine direction and are at least partially surrounded by the chopped reinforcement fibers. The continuous elements may be substantially evenly spaced or irregularly spaced apart. The chopped reinforcement fibers may be glass fibers, natural fibers, mineral fibers, carbon fibers, ceramic fibers and/or synthetic fibers and the continuous element may be formed from glass fibers, natural fibers, carbon fibers, and/or synthetic fibers. In preferred embodiments, the continuous element may be a wet continuous glass strand or a continuous yarn. The wet continuous glass strand has a bundle tex from about 50 to about 4800 g/km. In addition, the fibers forming the continuous elements preferably have diameters from about 7.5 to about 23 microns. The dry continuous yarn desirably has a bundle tex from about 10 to about 75 g/km.

It is another object of the present invention to provide a method of forming a reinforced chopped strand mat that includes (1) immersing at least one continuous element in a slurry containing chopped reinforcement fibers, (2) depositing the continuous element(s) and chopped reinforcement fibers onto a foraminous conveying apparatus to form a non-woven web, (3) applying at least one binder to the non-woven web, and (4) curing the binder to form a reinforced chopped strand mat. The continuous elements are buried within the chopped strand mat and are surrounded by the chopped reinforcement fibers. Additionally, the continuous elements are oriented in a substantially parallel orientation in the machine direction. The continuous elements may be formed of any continuous fiber strand, thread, roving, or yarn that possesses reinforcing qualities, but are preferably formed of wet continuous glass strands. It is desirable that the continuous elements have a bundle tex from about 50 to about 4800 tex. In addition, the fibers forming the continuous elements preferably have diameters from about 7.5 to about 23 microns. The continuous elements may be substantially evenly spaced apart at a distance from about 0.25 of an inch to about 3.0 inches. Alternatively, the continuous elements may be irregularly spaced within the chopped strand mat.

It is an advantage of the present invention that the addition of continuous elements to the chopped strand mat simultaneously improves the tear and tensile strength of the chopped strand mat.

It is a further advantage of the present invention that the inclusion of continuous elements in the chopped strand mat permits the chopped strand mat to obtain the minimum basis weight required by the shingle industry while meeting or exceeding the mechanical properties required for shingle production at lower costs.

It is yet another advantage of the present invention that the wet continuous glass strand has low manufacturing costs which help to prevent an increase in overall production costs for the chopped strand mat.

It is a feature of the present invention that the continuous elements may be embedded within the wet-laid chopped strand mat or positioned near a surface of the chopped strand mat.

It is another feature of the present invention that the reinforced chopped strand mat is lighter than a conventional chopped strand mat as a result of the reduction in the amount of chopped fibers in the mat.

It is yet another feature of the present invention that the unidirectional, continuous elements positioned in the machine direction in the chopped strand mat increase the overall strength of the mat.

It is a further feature of the present invention that the reinforced chopped strand mat can have a lower basis weight due to the inclusion of continuous elements into the chopped strand mat.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a processing line for forming wet chopped strand glass fibers according to one exemplary embodiment of the present invention;

FIG. 2 is a schematic illustration of a wet processing line for forming a chopped strand mat reinforced with wet continuous glass fiber strands according to one exemplary embodiment of the present invention;

FIG. 2A is a schematic illustration of a processing line for forming a chopped strand mat reinforced with continuous strands of yarn according to another exemplary embodiment of the present invention;

FIG. 3 a schematic illustration of a processing line for forming continuous elements according to one exemplary embodiment of the present invention;

FIG. 4 is a top plan view of a reinforced chopped strand mat according to at least one exemplary embodiment of the present invention;

FIG. 5 is a schematic illustration of an alternate wet processing line for forming a reinforced chopped strand mat utilizing wet continuous glass strands as the continuous elements according to the present invention; and

FIG. 5A is a schematic illustration of an alternate processing line for forming a reinforced chopped strand mat utilizing continuous strands of yarn as the continuous elements according to the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “sizing composition” and “size” may be used interchangeably herein.

The present invention relates to the inclusion of one or more continuous elements into a non-woven mat, such as a roofing mat. The continuous element may be formed of any continuous fiber strand, thread, roving, or yarn that possesses reinforcing qualities. The utilization of a continuous element in a non-woven mat simultaneously increases both the tensile and tear strength of the reinforced non-woven mat. In at least one embodiment of the present invention, the continuous element is a continuous wet glass strand. Because the wet, continuous element is not dried prior to use, the continuous element has low manufacturing costs which helps to prevent an increase in overall production costs. The reinforced chopped strand mat may be formed of randomly dispersed chopped glass fibers with at least one continuous element positioned such that the continuous element(s) are buried within the chopped glass fibers. Alternatively, the continuous element(s) may be positioned such that the continuous elements are at least partially surrounded by the chopped glass fibers.

The fibers used to form the non-woven mat are not particularly limited, and may be any type of glass fiber, such as A-type glass fibers, C-type glass fibers, E-type glass fibers, S-type glass fibers, ECR-type glass fibers (e.g., Advantex® glass fibers commercially available from Owens Coming), wool glass fibers, or combinations thereof. The use of other reinforcing fibers such as natural fibers, mineral fibers, carbon fibers, ceramic fibers, and/or synthetic fibers such polyester, polyethylene, polyethylene terephthalate, polypropylene, polyamide, aramid, and/or polyaramid fibers are considered to be within the purview of the invention. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cotton, jute, bamboo, ramie, bagasse, hemp, coir, linen, kenaf, sisal, flax, henequen, and combinations thereof. Although a wide variety and combination of fibers are possible, it is preferred that a majority of the fibers forming the non-woven mat are glass fibers, and even more preferably, all of the fibers in the mat are glass fibers. In this regard, and for ease of explanation, the non-woven mat will be described hereinafter with respect to glass fibers.

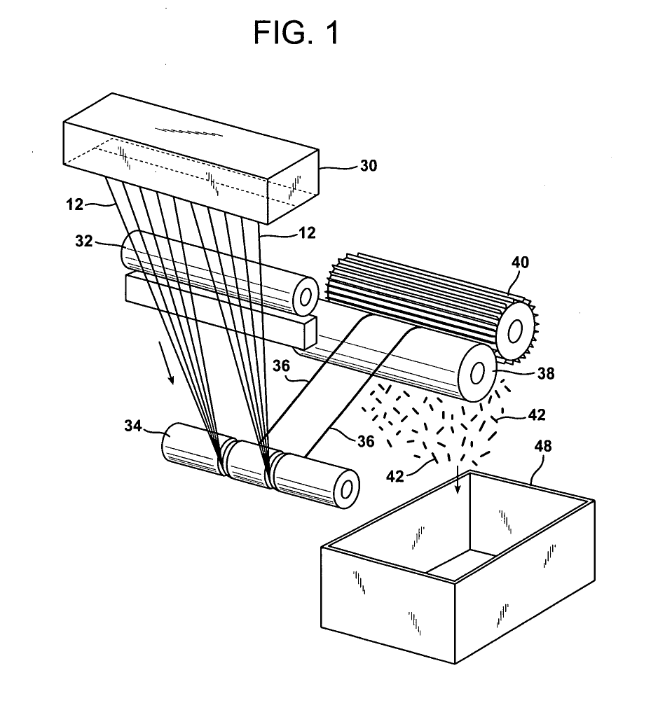

The non-woven mat is desirably formed of chopped glass fibers. As shown in FIG. 1, glass fibers 12 may be formed by attenuating streams of a molten glass material (not shown) from a bushing 30. The attenuated glass fibers 12 may have diameters from about 8 to about 23 microns, preferably from about 10 to about 16 microns. After the glass fibers 12 are drawn from the bushing 30, an aqueous sizing composition is applied to the fibers 12. The sizing may be applied by conventional methods such as by the application roller 32 shown in FIG. 1 or by spraying the size directly onto the fibers (not shown) to achieve a desired amount of the sizing composition on the fibers 12. Other application methods such as a kiss roll, dip-draw, or slide are easily identifiable by one of skill in the art. The size protects the glass fibers 12 from breakage during subsequent processing, helps to retard interfilament abrasion, and ensures the integrity of the strands of glass fibers, e.g., the interconnection of the glass filaments that form the strand.

The size composition applied to the glass fibers 12 typically includes one or more film forming agents (such as a polyurethane film former, a polyester film former, and/or an epoxy resin film former), at least one lubricant, and at least one coupling agent (desirably a silane coupling agent such as an aminosilane or methacryloxy silane coupling agent). Film formers create improved adhesion between the glass fibers 12, which result in improved strand integrity. The film former also acts as a polymeric binding agent to provide additional protection to the glass fibers 12 and improves processability of the glass fibers 12, such as a reduction in fuzz generated by high speed chopping. Silane coupling agents enhance the adhesion of the film-forming polymer to the glass fibers and to reduce the level of fuzz, or broken fiber filaments, during subsequent processing. The lubricant facilitates manufacturing and reduces fiber-to-fiber abrasion. When needed, a weak acid such as acetic acid, boric acid, metaboric acid, succinic acid, citric acid, formic acid, and/or polyacrylic acid may be added to the size composition to assist in the hydrolysis of the silane coupling agent.

The size composition further includes water to dissolve or disperse the active solids for application onto the glass fibers. Water may be added in an amount sufficient to dilute the aqueous sizing composition to a viscosity that is suitable for its application to glass fibers and to achieve the desired solids content on the fibers. In particular, the size composition may contain up to about 99% water. The size composition may be applied to the fibers 12 with a Loss on Ignition (LOI) of approximately 0.05-0.25 percent on the dried fiber. LOI may be defined as the percentage of organic solid matter deposited on the glass fiber surfaces.

After the glass fibers 12 are treated with the sizing composition, they are gathered into two individual tows 36 by a gathering shoe 34. The tows 36 are passed from the gathering shoe 34 to cutting device such as a chopper 40/cot 38 combination where the fiber tows 36 are chopped into wet chopped glass strands 42 having a length of about 0.125 to about 3.0 inches, and preferably about 0.25 to about 1.25 inches. The wet chopped glass fibers 42 may be collected in a container 48 for use at a later time, as illustrated in FIG. 1.

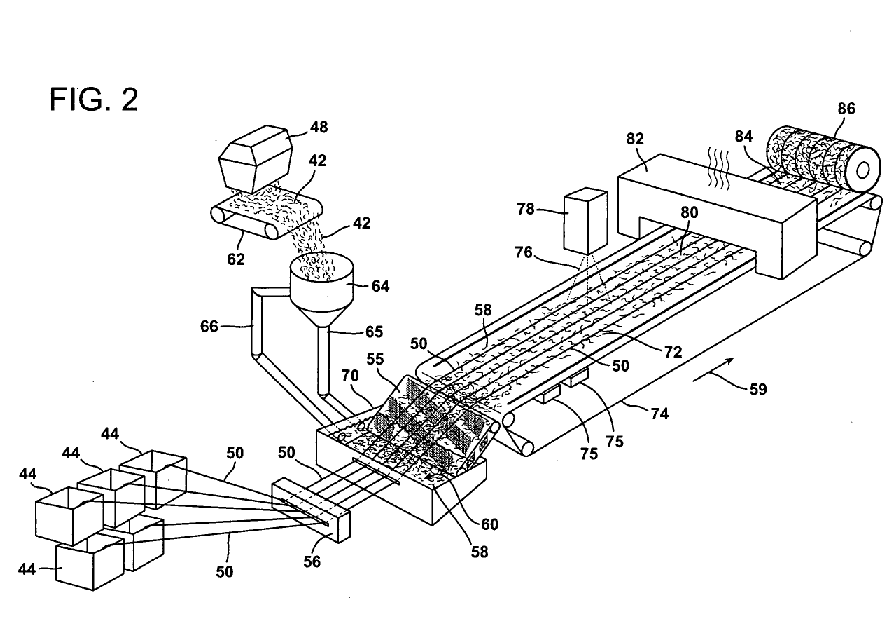

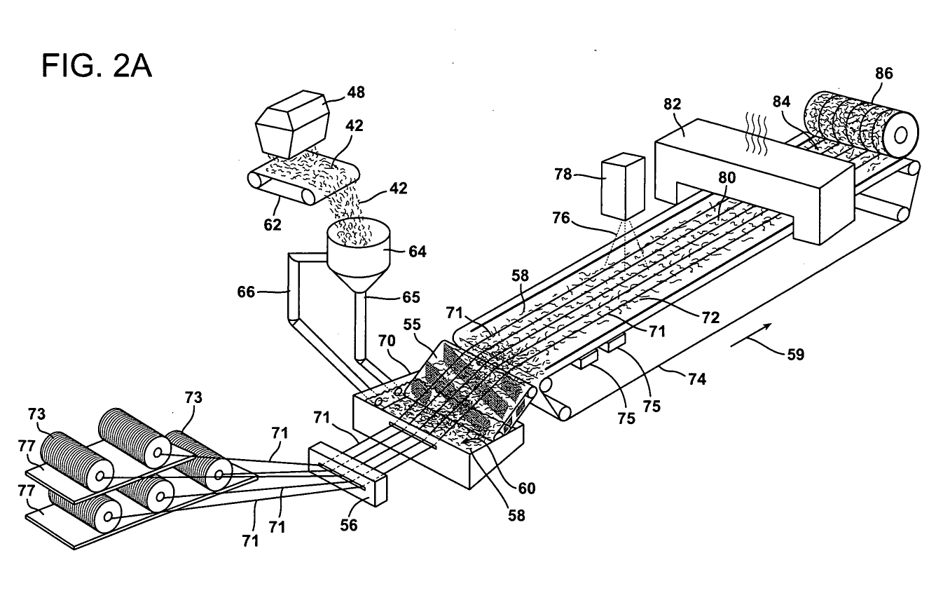

In one exemplary embodiment, the wet chopped glass fibers 42 are used to form a reinforced non-woven mat 84. As shown in FIG. 2, the wet chopped glass strands 42 may be deposited or otherwise conveyed onto a conveyor 62 from the storage container 48. The chopped glass fiber strands 42 are placed into a mixing tank 64 that contains various surfactants, viscosity modifiers, defoaming agents, and/or other chemical agents with agitation to disperse the fibers 12 from the chopped glass strands 42 and form a chopped glass fiber slurry (i.e., whitewater). The whitewater is then transferred to a head box 70 via a conveying device, such as a tube 65. Whitewater from the head box 70 is recirculated into the mixing tank 64 via conduit 66.

At least one continuous element is added to the headbox 70 in addition to the whitewater. The continuous element may be formed of any continuous fiber strands or bundles with a variety of tex, such as rovings and/or yarns. Glass fibers, natural fibers, carbon fibers, and/or synthetic fibers (e.g., aramid fibers, polyaramid fibers, polypropylene fibers, and polyester fibers) may be used to form the continuous element. The continuous element may be a wet continuous strand or a dried yarn, and encompasses a wide range of bundle tex. It is desirable that the continuous element has a bundle tex from about 50 to about 4800 tex, preferably from about 60 to about 1000 tex to permit for cutting in subsequent steps. Tex is defined as g/km. In the embodiment depicted in FIG. 2, the continuous element is a wet continuous glass strand 50.

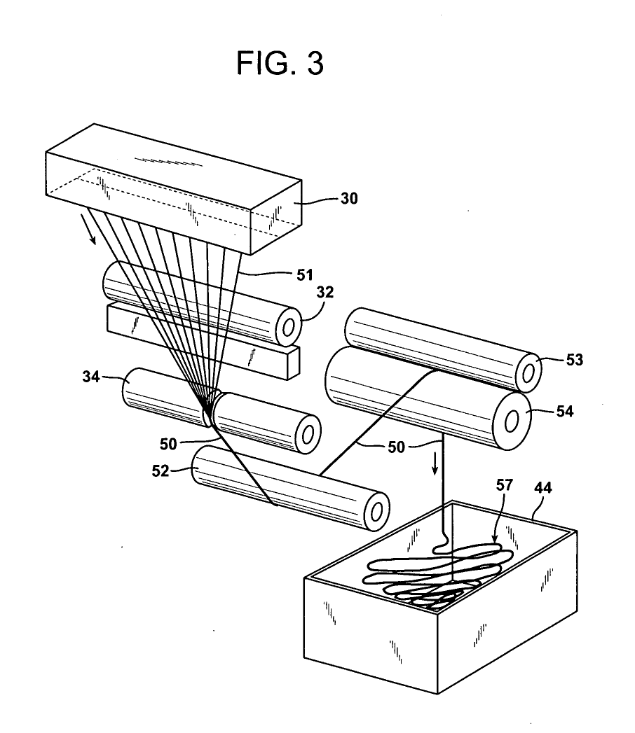

The wet continuous glass strand 50 may be formed as depicted in FIG. 3. In particular, glass fibers 51 are formed by attenuating streams of a molten glass material (not shown) from a bushing 30. The attenuated glass fibers 51 may have diameters from about 7.5 to about 23 microns, preferably from about 10 to about 16 microns. An aqueous sizing composition is applied to the fibers 51 by any conventional method, such as by an application roller 32. Other application methods (e.g., spraying, immersion, and the like) would be easily identifiable by one of skill in the art, and are considered to be within the purview of the invention. The size composition applied to fibers 51 forming the continuous elements may be the same as or different from the size composition applied to the fibers 12 that form the wet chopped glass strands 42. Preferably, the size composition on for the fibers 12 forming the wet chopped glass strands 42 and the fibers 51 forming the wet continuous glass strands 50 are compatible with the matrix resin material to facilitate wet-out and provide adequate physical properties to the final composite part.

After the application of the sizing composition, the sized glass fibers 51 are gathered by a gathering shoe 34 into the wet continuous element 50. It is desirable that the wet continuous glass strand 50 has a bundle tex from about 50 to about 4800 tex, preferably from about 250 to about 2000 tex, and more preferably from about 700 to about 1000 tex. The wet continuous element 50 is pulled by a combination of rollers 53, 54 past guide roller 52 and is collected into a storage or collection container 44. The container thus contains loose, wet continuous strands 50, commonly referred to as “wet rattlesnake” 57.

Turning back to FIG. 2, wet continuous glass strands 50 are fed into the headbox 70 from storage containers 44. As shown in FIG. 2, the wet continuous glass strands 50 are fed into the headbox 70 in a parallel or substantially parallel formation and are substantially equidistant from each other. As used herein, the phrase “substantially parallel” is meant to denote that the continuous elements are parallel or nearly parallel to each other. “Substantially equidistant” is meant to indicate that the continuous elements or other items or elements are equally or nearly equally spaced. The continuous glass strands 50 may be spaced anywhere from about 0.25 inches to about 3.0 inches from each other. It is to be noted, however, that it is within the scope of the invention to have some of the continuous elements 50 in the mat spaced closer to each other in one portion of the reinforced chopped strand mat and farther apart from each other in another portion of the reinforced mat (not illustrated), depending on the desired application. Irregularly spacing the continuous elements within the mat provides varying tensile and tear strengths throughout the chopped strand mat.

In order to pass the wet continuous glass strands 50 through the headbox 70 in a parallel or nearly parallel orientation, the wet continuous glass strands 50 may be fed through a strand separating apparatus 56 having equidistant spaces or holes (not shown) through which the wet continuous glass strands 50 pass. Examples of such strand separating devices 56 include a comb-type guide or a spacer board having therein eyelets spaced substantially equidistantly. Such devices are known by those of skill in the art and will not be discussed in detail herein. If the strand separating device 56 is a spacer board, the diameter of the eyelets within the spacer is generally slightly larger than the diameter of the corresponding wet continuous glass strand 50 passing therethrough. It is within the purview of the invention that one or more wet continuous glass strands 50 may pass together as a single unit through the strand separating apparatus 56 and into the headbox 70.

The slurry containing the continuous elements 50 and wet fibers 58 dispersed from the wet chopped strands 42 are removed from the headbox 70 by a forming wire 55 and deposited onto a conveying apparatus 74 (e.g., a moving screen or foraminous conveyor). The wet continuous glass strands 50 are oriented in the machine direction and the dispersed wet glass fibers 58 are dispersed in a randomly oriented configuration at least partially around the wet continuous glass strands 50. Thus, the wet continuous glass strands 50 are integral to the chopped strand mat 84 and provide reinforcing elements to the chopped strand mat 84. Additionally, the wet continuous glass strands 50 simultaneously improve tensile strength and tear strength of the reinforced chopped strand mat 84. It is to be noted that the level or amount of increase in the tear and tensile strengths of the reinforced chopped strand mat 84 is dependent upon the number and type (e.g., continuous glass strands vs. yarn) of continuous elements 50 positioned on or in the reinforced mat 84. For example, increasing the number of continuous elements in the chopped strand mat 84 increases the tensile and tear strengths.

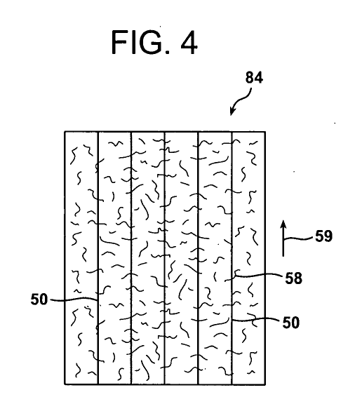

Once the wet fibers 58 and the wet continuous strands 50 are deposited onto the conveying apparatus 74 to form a reinforced non-woven web 72. Water may be removed from the reinforced web 72 by one or more conventional vacuum or air suction systems 75. A binder 76 is then applied to the reinforced web 72 by a binder applicator 78. The binder-coated reinforced web 80 is then passed through a drying oven 82 to remove any remaining water and at least partially cure the binder 76. The reinforced non-woven chopped strand mat 84 that emerges from the oven 82 includes randomly dispersed glass fibers 58 and continuous elements 50 that are oriented in a unidirectional and parallel, or substantially parallel orientation in the machine direction of the mat 84. Such a reinforced chopped strand mat 84 is illustrated in FIG. 4. The machine direction is depicted by arrow 59. In at least one exemplary embodiment, the continuous elements (e.g. wet continuous glass strands) are placed generally evenly across the width of the chopped strand mat. The reinforced chopped strand mat 84 may be rolled onto a take-up roll 86 for storage. In this embodiment, the wet continuous strands 50 are positioned at or near a surface of the chopped strand mat 84 and are at least partially surrounded by the glass fibers 58.

The binder 76 may be an acrylic binder, a styrene acrylonitrile binder, a styrene butadiene rubber binder, a urea formaldehyde binder, or mixtures thereof. Preferably, the binder is a standard thermosetting acrylic binder formed of polyacrylic acid and at least one polyol (e.g., triethanolamine or glycerine). The binder 76 may optionally contain conventional additives for the improvement of process and product performance such as dyes, oils, fillers, colorants, UV stabilizers, coupling agents (e.g., aminosilanes), lubricants, wetting agents, surfactants, and/or antistatic agents.

Instead of utilizing wet continuous glass strands 50 to form the reinforced chopped strand mat 84, yarn may be substituted as the continuous element. Such an embodiment is depicted in FIG. 2A. Yarn generally contains a smaller number of glass filaments per gathered bundle of fibers (i.e. yarn strand) with smaller fiber diameters than the fibers forming the wet continuous glass strands 50. The fibers within the yarn are preferably glass fibers, but non-glass reinforcing fibers such as natural fibers, mineral fibers, carbon fibers, ceramic fibers, and/or synthetic fibers (e.g., nylon) may also or alternatively be used. The bundle tex of the yarn is generally from 10 to about 75 tex, preferably from about 50 to about 75 tex. Additionally, the diameter of the glass fibers forming the yarn is typically from about 3.0 to about 10 microns. Having a small bundle tex and small fiber diameter permits the reinforced mat 84 to be easily wound for storage.

The embodiment depicted in FIG. 2A is identical to that depicted in FIG. 2, with the exception that a dry, continuous yarn 71 is fed from bobbins 73 into the headbox 70 where it becomes saturated with the components of the whitewater 60. The yarn 71 is desirably unraveled from the bobbins 73 at the same speed as the mat line to ensure an even placement of the yarn 71 within the reinforced mat. The bobbins 73 may be positioned on supports 77. As with the embodiment depicted in FIG. 2, water from the reinforced web 72 is removed by one or more conventional vacuum or air suction systems 75, a binder 76 is applied to the web 72 by a binder applicator 78, and the binder-coated reinforced web 80 is passed through a drying oven 82. The reinforced non-woven chopped strand mat 84 that exits from the oven 82 is formed of randomly dispersed glass fibers 58 and continuous yarn strands oriented in a parallel or substantially parallel orientation in the machine direction of the mat 84. The yarn strands are the reinforcing, unidirectional elements that provide additional strength to the chopped strand mat 84.

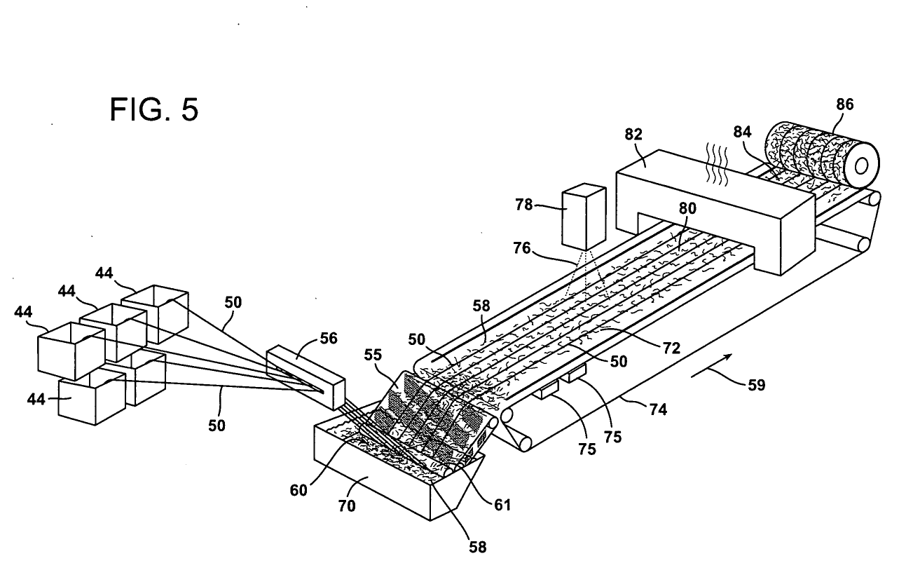

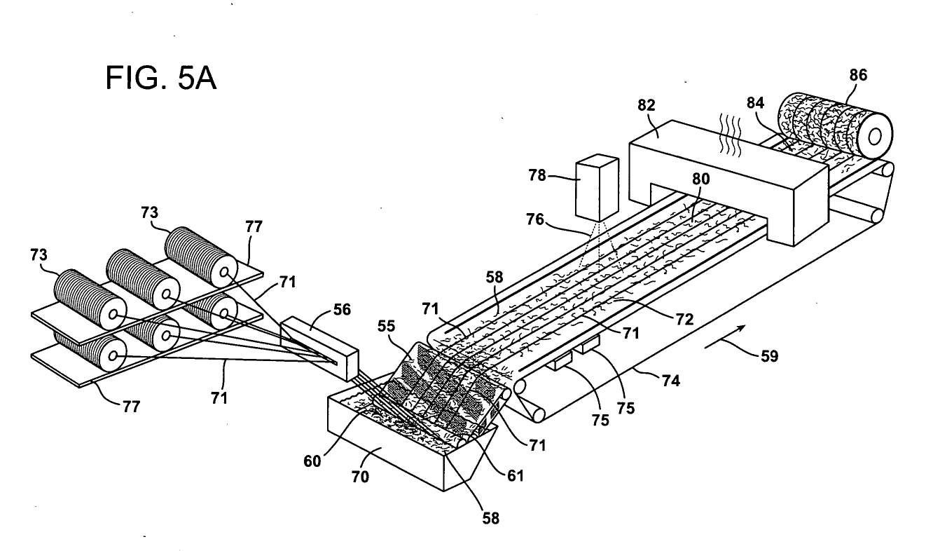

An alternate embodiment for forming a reinforced chopped strand mat according to the present invention is depicted in FIG. 5. In this embodiment, wet continuous glass stands 50 are fed from containers 44 and are immersed in the whitewater 60 containing the dispersed glass fibers 58. The wet continuous glass fibers 50 are immersed in the whitewater 60 with the aid of a bar 61. The wet glass fibers 58 and the wet continuous glass strands 50 are conveyed from the head box 70 onto a conveying apparatus 74 (e.g., forming wire or formaminous conveyor) by a forming wire 55. Water is removed from the web 72 formed of chopped fibers 58 and continuous glass strands 50 by one or more conventional vacuum or air suction systems 75. A binder such as the binder 76 discussed in detail above is added to the web 72 and the binder-coated web 80 is dried in a conventional drying oven 82 to at least partially cure the binder. The reinforced chopped strand mat 84 is formed of randomly dispersed glass fibers 58 and parallel or nearly parallel continuous glass strands 50 buried within the dispersed glass fibers 58. Thus, the wet continuous glass strands 50 are positioned within the chopped strand mat 84. In a preferred embodiment, the continuous glass strands 50 are positioned at or near the center of the chopped strand mat 84.

In a further alternate embodiment depicted in FIG. SA, yarn 71 is utilized as the continuous element instead of the wet continuous glass strands 50. In this alternate embodiment, the yarn 71 is fed from bobbins 73 into the whitewater 60. The bobbins 73 may be supported by supports 77. The yarn 71 is immersed in the whitewater 60 with the assistance of bar 61. The wet glass fibers 58 and yarn 71 are deposited onto the forming wire 55 and conveyed to the conveying apparatus 74 to form a non-woven web 72. Water is removed from the web 72 by one or more conventional vacuum or air suction systems 75, a binder is added to the web 72, and the binder-coated web 80 is dried in a conventional drying oven 82 to cure the binder. The reinforced chopped strand mat 84 is formed of randomly dispersed glass fibers 58 and parallel or nearly parallel yarns buried within the dispersed glass fibers 58 (and within the chopped strand mat 84).

The dried reinforced chopped strand mat 84, containing either the continuous glass strands or yarns, may be utilized to form reinforced composites, including reinforced building or roofing composites such as shingles. For example, asphalt may be applied to the reinforced chopped strand mat 84 by any known manner, such as by passing the mat 84 through a bath containing an asphalt mix that may include molten asphalt and fillers to place a layer of asphalt on at least one side of the mat and to fill the interstices between the individual glass fibers. The asphalt-coated mat may then be cut to the appropriate shape and size to form a shingle. In addition, the hot asphalt-coated mat may be passed beneath one or more granule applicators which apply protective surface granules to portions of the asphalt-coated mat prior to cutting the coated mat into the desired shape. The inclusion of continuous elements in the chopped strand mat permits the chopped strand mat to obtain the minimum basis weight required by the shingle industry while simultaneously meeting or exceeding the mechanical properties (e.g., tensile and tear strengths) required to produce an adequate and commercially acceptable shingle. Further, the addition of the continuous elements in the chopped strand mat reduces the amount of chopped glass fibers in the mat, thus making the reinforced mat lighter in weight. As a result, more shingles per pound of mat may be produced utilizing the reinforced mats of the present invention.

There are numerous advantages provided by adding the continuous elements to a randomly oriented chopped strand mat as described herein. For instance, the addition of continuous elements to the chopped strand mat simultaneously improves the tear and tensile strengths of the chopped strand mat. Additionally, the reinforced chopped strand mat may have a lower basis weight due to the inclusion of the continuous elements into the chopped strand mat. Further, the amount of chopped fibers required to form a strong chopped strand mat is reduced as a result of the addition of the continuous elements. In addition, the reinforced chopped strand mat is lighter as a result of the reduction in the amount of chopped fibers in the mat. Also, the unidirectional, continuous elements positioned in the machine direction within the chopped strand mat enhance the properties of the chopped strands and increases the overall strength of the mat.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A reinforced chopped strand mat comprising:
a plurality of randomly dispersed chopped reinforcement fibers bound together by a binder to form a non-woven chopped strand mat; and
at least one continuous element positioned in a substantially parallel orientation in the machine direction of said chopped strand mat, said chopped strand mat having two major surfaces,
wherein said at least one continuous element is at least partially surrounded by said chopped reinforcement fibers.

2. The reinforced chopped strand mat of claim 1, wherein said at least one continuous element is buried within said chopped strand mat.

3. The reinforced chopped strand mat of claim 1, wherein said at least one continuous element is positioned at one of said major surfaces.

4. The reinforced chopped strand mat of claim 1, wherein said at least one continuous element comprises two or more of said continuous elements and each of said continuous elements are positioned a distance from about ¼ of an inch to about 3 inches apart.

5. The reinforced chopped strand mat of claim 1, wherein said at least one continuous element comprises two or more of said continuous elements and said two or more said continuous elements are irregularly spaced within said chopped strand mat.

6. The reinforced chopped strand mat of claim 1, wherein said at least one continuous element simultaneously improves the tear and tensile strengths of said chopped strand mat.

7. The reinforced chopped strand mat of claim 1, wherein said continuous element is selected from a wet continuous glass strand and a dried yarn.

8. The reinforced chopped strand mat of claim 7, wherein said wet continuous glass strand has a bundle tex from about 50 to about 4800 g/km and wherein said dried yarn has a bundle tex from about 10 to about 75 g/km.

9. A method of forming a reinforced chopped strand mat comprising:
depositing one or more continuous elements and chopped reinforcement fibers onto a conveying apparatus to form a non-woven web;
applying at least one binder to said non-woven web; and
drying said non-woven web to at least partially cure said binder and form a reinforced chopped strand mat having two major surfaces, said reinforced chopped strand mat having a plurality of randomly dispersed chopped reinforcement fibers and said one or more continuous elements positioned in a substantially parallel orientation in the machine direction,
wherein said one or more continuous elements is positioned at one of said two major surfaces such that said one or more continuous elements is at least partially surrounded by said chopped reinforcement fibers.

10. The method of claim 9, wherein said one or more continuous elements is at least one member selected from the group consisting of a wet continuous glass strand and a dry continuous yarn.

11. The method of claim 10, wherein said continuous element is a dry continuous yarn having a bundle tex from about 10 to about 75 g/km.

12. The method of claim 9, wherein said chopped strand mat contains a plurality of continuous elements, and
wherein said continuous elements are wet continuous glass strands.

13. The method of claim 9, further comprising:
feeding said one or more continuous elements through openings in a separating apparatus prior to said depositing step, said openings being substantially equidistantly spaced.

14. The method of claim 13, wherein said chopped strand mat contains a plurality of continuous elements and said continuous elements are substantially equidistantly positioned a distance from about 0.25 inches to about 3 inches apart.

15. The method of claim 9, wherein said chopped strand mat contains a plurality of continuous elements and said continuous elements are irregularly spaced within said chopped strand mat.

16. A method of forming a reinforced chopped strand mat comprising:
immersing at least one continuous element in a slurry containing chopped reinforcement fibers, said at least one continuous element being substantially parallel in the machine direction;
depositing said at least one continuous element and said chopped reinforcement fibers onto a foraminous conveying apparatus to form a non-woven web;
applying at least one binder to said non-woven web; and
heating said non-woven web to at least partially cure said binder to form a reinforced chopped strand mat, said one or more continuous elements being buried within said chopped strand mat and surrounded by said chopped reinforcement fibers.

17. The method of claim 16, wherein said reinforced chopped strand mat contains a plurality of continuous elements positioned a distance from about 0.25 inches to about 3 inches apart.

18. The method of claim 16, wherein said chopped strand mat contains a plurality of continuous elements and said continuous elements are irregularly spaced within said chopped strand mat.

19. The method of claim 16, wherein said continuous element is one or more members selected from the group consisting of a wet continuous glass strand and a dry continuous yarn.
